(19) United States
(12) Patent Application Publication
(10) Pub. No.: US 2019/0242445 A1
(43) Pub. Date: Aug. 8, 2019

(54) ELECTROHYDRAULIC SYSTEM FOR ACTUATING MULTIPLE-DISC CLUTCHES AND GEAR ACTUATORS WITH HIGHLY PRECISE CONTROL OF A PLURALITY OF TRANSMISSION UNITS SIMULTANEOUSLY

(71) Applicant: LSP Innovative Automotive Systems GmbH, Unterföhring (DE)

(72) Inventors: Thomas LEIBER, Rogoznica (HR); Valentin UNTERFRAUNER, München (DE); Rainer WINZER, München (DE)

(73) Assignee: LSP Innovative Automotive Systems GmbH, Unterföhring (DE)

(21) Appl. No.: 16/331,219

(22) PCT Filed: Feb. 28, 2017
(86) PCT No.: PCT/EP2017/054641

§ 371 Date: Mar. 7, 2019

(30) Foreign Application Priority Data
Sep. 7, 2016 (DE) 10 2016 116 778.9
Sep. 29, 2016 (DE) 10 2016 118 423.3

(51) Int. Cl. F16D 48/06; F15B 7/00; F16D 25/12; F16H 61/00; F16H 61/28; F16H 61/688

(52) U.S. Cl. CPC F16D 48/066; F15B 7/003; F16D 25/12; F16D 2500/70406; F16H 61/2807; F16H 61/688; F16H 61/0021

(57) ABSTRACT

A shift gearbox may include at least two driven piston-cylinder units, which are each driven via a transmission of a drive, and the piston-cylinder units may each comprise a piston, which delimits a working chamber, and each working chamber is in hydraulic connection with at least one clutch actuator and at least one gear selector via a hydraulic main line, whereby the clutch actuator comprises a working chamber delimited by a piston. A valve may be respectively arranged between each working chamber of a clutch actuator and a hydraulic main line, and both the pressure build-up and the pressure reduction in the clutch actuators may occur by adjusting the piston of a piston-cylinder unit.

The present invention relates to a shift gearbox according to the preamble of claim 1.

### PRIOR ART

From DE 10 2006 038 446 A1 a shift gearbox with an electromotively driven piston-cylinder unit is described in which one or two piston-cylinder units operate four gear selectors and two clutches. The piston-cylinder unit generates the pressure required for adjusting the gear selectors and clutches, whereby a pressure sensor measures the pressure generated. DE 10 2006 038 446 A1 describes two possible embodiments for this purpose. In the first embodiment, clutches and gear selectors are adjusted over for actuation of so-called multiplex valves by means of the piston-cylinder unit. In this case, the pressure build-up and the pressure reduction can take place via the piston-cylinder unit. However, it is also possible that for some or all consumers additional exhaust valves are provided, via which the pressure in the individual consumers can be regulatedly lowered.

From DE 10 2006 014 280, a shift gearbox is already known in which the clutch actuator and gear selector are adjusted by means of second piston-cylinder units, wherein the pressure build-up and reduction takes place in the clutch actuators via proportional valves.

### OBJECT OF THE INVENTION

The object of the invention is to further improve the shift gearbox known from DE 10 2006 038 446 A1.

This object is achieved with a shift gearbox according to the invention with the features of claim 1. Advantageous embodiments of this shift gearbox result from the features of the dependent claims.

The invention is advantageously characterised in that a valve is arranged between each working chamber of a clutch actuator and a main hydraulic line, and both the pressure build-up and the pressure reduction in the clutch actuators takes place by adjusting the piston of a piston-cylinder unit, whereby the valve for the pressure change in the clutch actuator is opened and closed to maintain pressure in the clutch actuator, as well as to deactivate the clutch actuator while other shift gearbox units of the respective hydraulic main line are operated. As a result, a high-precision control of a multiple clutch system is possible, wherein a plurality of gear selectors and at least two clutches can be switched. The valves employing the clutch actuator of the piston-cylinder units, which serve to adjust the clutch plate, may advantageously be pure 2/2-way switching valves, as no proportional control takes place over them. Rather, the pressure build-up and reduction takes place via the adjustment of the respective piston of the associated piston-cylinder unit. In this case, the volume of fluid required for switching the clutch actuator is advantageously displaced with the piston-cylinder unit via a volume control. In doing so, advantageously, a pressure volume characteristic can be used, in which the pressure change is stored at a corresponding path change of the piston of the piston-cylinder unit. In addition, a model can be used which simulates the corresponding relationships and thus required control variables and parameters can be determined, whereby a precise pressure gradient control is possible. In the shift gearbox according to the invention, expensive proportional valves can thus advantageously be dispensed with.

The shift gearbox according to the invention thus advantageously manages to meet the very high demands on a very precise pressure regulation (micro-slip control) of the clutches with an angle sensor on the drive of a piston-cylinder unit. During the simultaneous switching of two clutches—one clutch is opened while the other clutch is closed—as well as during gear shifting, it may happen that the load of the engine changes and thus the clutch must be readjusted (slip control), so that the driver does not perceive the gear change, allowing maximum ride comfort to be achieved.

This is not possible with a classic control via pressure transducers or pressure sensors, since pressure transducers do not have resolution like an angle sensor of an electric motor. If a pressure transducer is used to determine the pressure or the piston force on the clutch (force or clutch torque=area*pressure), the usual pressure transducers only achieve a resolution of approx. 0.5 bar. The use of an angle sensor, however, brings a higher resolution by a factor of 10. A pressure transducer with correspondingly high resolution, however, is much more expensive. The angle sensor may be e.g. a classic Hall sensor, which can be very cheap and is also easy to read.

The gear selectors of the shift gearbox according to the invention generally comprise respectively a first and a second working chamber separated by a piston, wherein the working chambers of the clutch actuator are in communication with the respectively associated hydraulic main line via hydraulic connecting lines. The first working chambers of the gear selectors are in each case in communication with the respectively associated hydraulic main line by means of hydraulic connecting lines, wherein the hydraulic connecting lines can each be shut off by means of a switching valve.

The two working chambers delimiting piston surfaces of the piston of the gear selector are formed in different sizes, wherein the larger piston surface delimits the first working chamber.

In a first embodiment, the second working chambers of the gear selectors are connected to the same hydraulic main line with which the hydraulic feed lines are also connected, in which the switching valve associated with the control valve is arranged. In a second possible embodiment, however, the second working chambers of the gear selector are connected with the other hydraulic main line by means of a respective hydraulic connecting line, the hydraulic supply line of the respective gear selector being not directly connected with the other hydraulic main line, in that the associated switching valve is arranged in the gear selector.

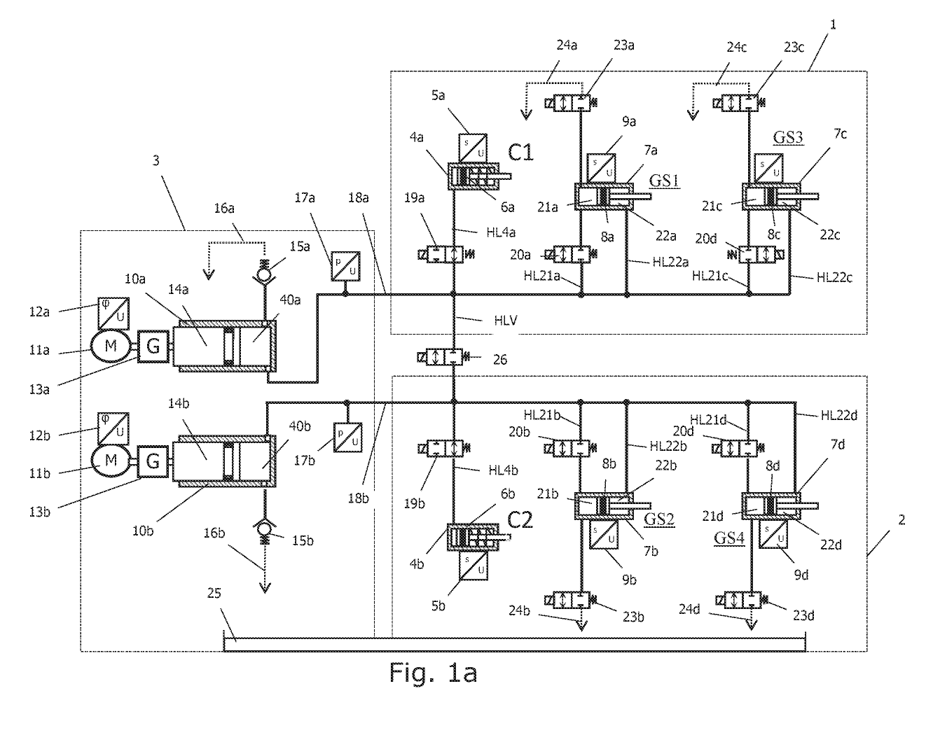

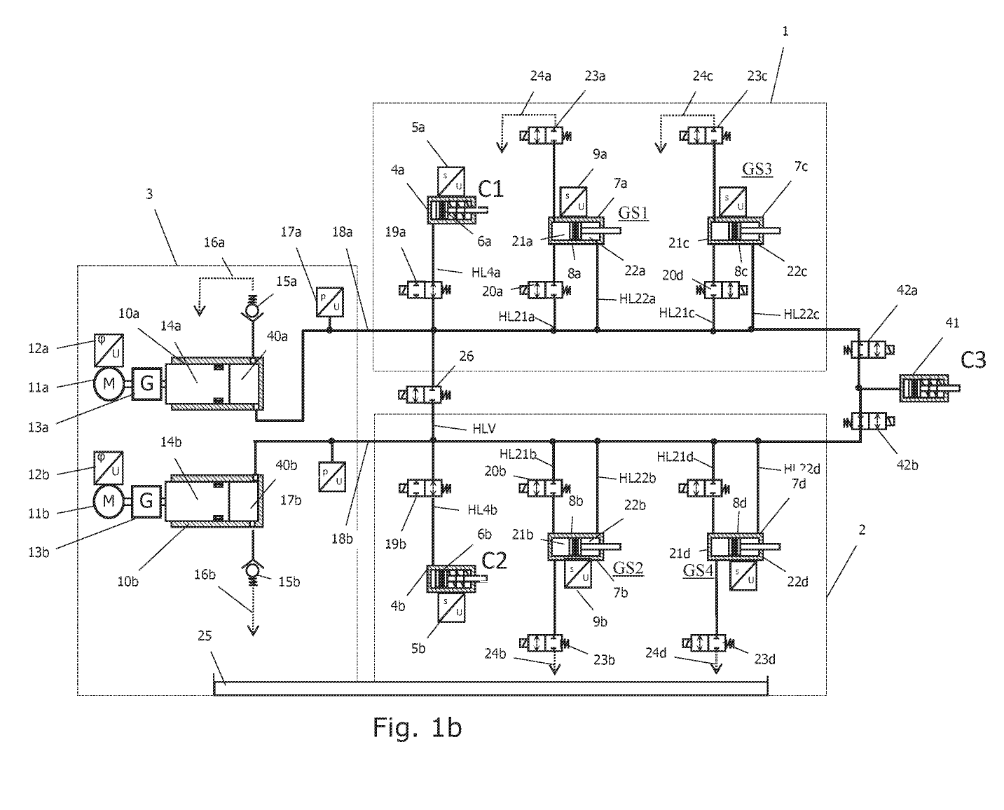

In the first embodiment described above, the first working chamber of at least one gear selector is in connection with a reservoir via a hydraulic line, wherein a switching valve, in particular a 2/2-way valve, is arranged for selectively opening and shutting off the hydraulic line in this. In this embodiment, which is shown and described in FIGS. 1a and 1b, e.g. when adjusting the respective gear selector, e.g. 7a, to the right, the associated valve 20a is opened and the valve 23a, which is arranged in the hydraulic line leading to the reservoir, is closed. If the piston of the piston-cylinder unit is adjusted, then a pressure in the hydraulic main line will be established by the displacement of the hydraulic medium. Due to the differently sized piston surfaces, which delimit the two working chambers of the gear selector, a resultant force F=p*(A₂₁ₐ−A₂₂ₐ) results, which adjusts the piston of the gear selector to the right. In this case, the built-up pressure determines the adjustment speed of the piston of the gear selector and the volume of the hydraulic medium displaced by means of the piston of the piston-cylinder unit determines the end position of the piston of the gear selector (volume control). By adjusting the piston of the gear selector to the left, the valve 20a will be closed and the valve 23a will be opened. By means of a volume control, hydraulic fluid will then be conveyed using the piston-cylinder unit into the appropriate working chamber of the gear selector. Atmospheric pressure prevails in the reservoir, resulting in a resultant force due to the different piston surfaces of the piston of the gear selector

ΔF=P₂₂ₐ*A₂₂ₐ−P₂₁ₐ*A₂₁ₐ,with P₂₁ₐ≈1 bar.

Advantageously, the two hydraulic main lines can be connected to one another via a hydraulic connecting line, wherein a switching valve for selectively opening or closing the hydraulic connecting line is arranged in the hydraulic connecting line. This advantageously results in many additional possibilities and redundancies. Thus, in the case of failure in one piston-cylinder unit, the other can take over its function via the connecting line. It is also possible that the hydraulic pressure stored in one clutch can be used to support the shifting of the other clutch.

The control unit, which controls the respective electromotive drive for adjusting at least one of the shift gearbox units, uses the rotation angle φ of the drive, the motor current i flowing through the drive, the piston location s and/or the distance Δs of the piston of the piston-cylinder unit as a manipulated variable for the control of the drive, so that the piston conveys a required hydraulic volume in or out of the respective one shift gearbox unit.

Advantageously, the shift gearbox units may comprise a location sensor or position sensor. Their signals can be advantageously used to control the drive and/or to calibrate the control and/or the simulation model.

If a pressure transducer is used, it will only be used for calibration or redundancy. Optionally, a very simple pressure transducer is sufficient for calibration purposes only, to detect a correlation of the current flowing through the electric motor to the pressure, in order that changes in the system, e.g. a change in efficiency of the trapezoidal spindle, can be taken into account. But this can also be done via a displacement sensor of the gear selector or clutches. The adjustment is critical if e.g. a trapezoidal spindle is used in the electric motor, which due to its properties has high efficiency fluctuations in its operation, e.g. if it is made of plastic. However, the use of the trapezoidal spindle leads to significant cost savings, the additional effort for one or more calibration sensors is conversely low.

Also, both hydraulic actuators can be adjusted in the form of the piston-cylinder units with only one pressure transducer. This can take place e.g. via the connecting line and the valve arranged therein, which connects the two hydraulic main lines together.

In addition, the system can advantageously be simplified in such a way as to dispense with displacement sensors in the clutch and gear selector. However, primarily for safety reasons (e.g., detection of leaks in the hydraulic system, checking the start and end locations before and after a gear shift), a very simple sensor, e.g. digital Hall switch to determine the discrete position of the gearshift (left, neutral, right), and clutches are used, whereby with the clutch only a discrete position is required. In the simplest case, only one calibration sensor is used for both piston-cylinder units. Clutches and gear selectors are then controlled exclusively via travel control of the motor with simultaneous use of the current of the electric motor for pressure calculation. This leads to limitations in accuracy. However, the convenience is sufficient, whereby the full functionality is ensured for simple vehicles.

Advantageously, the shift gearbox according to the invention can comprise more than two clutch actuators. Thus it is easily possible that three clutches and several gear selectors can be actuated with the two piston-cylinder units. In the case of three clutch actuators or clutches, two or one clutch and one gear selector can be simultaneously displaced or switched at the same time. Thus, the third clutch actuator can be selectively shut off from the two hydraulic main lines or connected to one of the two hydraulic main lines, for example via a supply line by means of a 3/3-way valve or at least two 2/2-way valves. However, it is also possible that the third clutch actuator is connected by means of a valve only to a hydraulic main line. In the latter case, however, the third clutch can no longer be controlled separately from the other two clutch actuators.

As already stated above, the energy stored hydraulically in another clutch can be used to switch over a clutch. In this case, in particular the stored energy from the one clutch occurs via the valve connecting the two hydraulic main lines together or via the one or two valves, by means of which the third clutch is connected to the two main hydraulic lines. The stored energy may be used to assist in the pressure build-up in another, e.g. the second clutch. Thus, the second piston-cylinder unit, which can also be referred to as a hydraulic actuator, can be discharged and can be designed for lower torques and power. This advantageously has significant effects on the costs, which are highly relevant in particular in a system with two piston-cylinder units or hydraulic actuators. As a result, the use of a trapezoidal spindle is possible, whereby further cost savings are possible.

It is also advantageously possible that at least one clutch is cooled by means of a cooling medium, wherein the cooling medium is conveyed by means of the drive of a piston-cylinder unit or a separate drive, which in particular drives a pump.

A particularly favourable shift gearbox is obtained when the power unit drives the piston via a trapezoidal spindle.

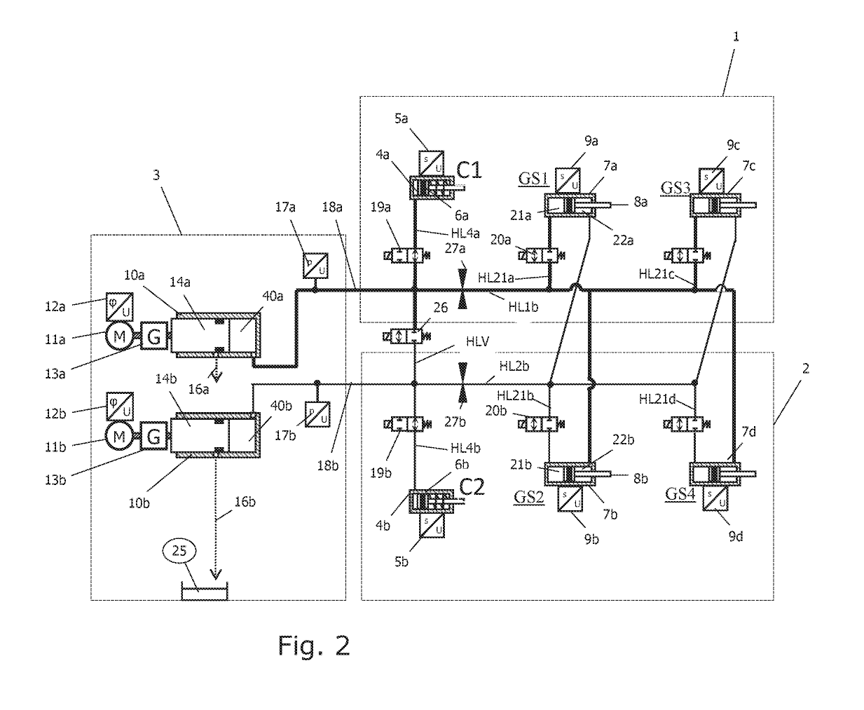

Furthermore, flow resistances may be arranged, in particular in the form of apertures in the hydraulic main lines, in particular in the sections connecting the clutch(es) with the gear selectors. For example, FIG. 2 shows a possible embodiment, where such an arrangement is advantageously used. In this case, a clutch can be controlled simultaneously via location or pressure and a gear position can be handled. The above-mentioned flow resistance in the form of an aperture prevents a rapid volume displacement in the piston of the hydraulic actuator 10a, for example in the case of an active control of the clutch C1 and a possible gear position to the left in the gear selector GS2. Due to this, with the opening through the switching valve 20b, it is possible to maintain a sufficiently accurate control on the clutch C1 while providing volume through the active hydraulic actuator 10a for a gear position. Finally, if the piston has moved sufficiently far to the left due to the higher pressure in HL1b than HL2b and the desired gear has been engaged, valve 20b can be closed again. The gear position, and moreover the gear position speed per se, in this method of course depends on the pressure provided in HL1b or on the pressure difference in HL1b and HL2b.

As already stated, the shift gearbox according to the invention is advantageous in that either the pressure build-up and pressure reduction takes place in at least two clutches simultaneously, temporally overlapping or successively by means of back and forth movements of the piston of the piston-cylinder units (10a, 10b), or the pressure build-up or pressure reduction takes place in a clutch with one of the piston-cylinder units, and an adjustment of a gear selector takes place simultaneously, temporally overlapping or successively by means of the other piston-cylinder units, wherein in the case of the pressure change in a clutch, the respective associated valve is open.

Thus, it is particularly advantageous if either the pressure build-up and/or pressure reduction occurs in the first clutch via the first piston-cylinder unit and the simultaneous pressure build-up and/or pressure reduction occurs in the second or third clutch via the second piston-cylinder unit, or the pressure build-up and/or pressure reduction occurs in the second clutch via the second piston-cylinder unit and the simultaneous pressure build-up and/or pressure reduction occurs in the third clutch via the first piston-cylinder unit, whereby in all cases the valves of the shift gearbox are connected such that the pressure change in one clutch does not affect the pressure change in another clutch.

Because of the travel control of the pistons of the piston-cylinder units, which corresponds to a volume control, advantageously a cost-effective design is possible, in that the design allows the number of valves required to be reduced. Due to the travel or volume control, it can easily be effected that at least one shift gearbox unit may comprise more than two switching locations, without a complex pressure regulation, since, due to the incompressibility of the hydraulic medium over a predetermined conveyed volume, the respective shift gearbox unit can be adjusted specifically in one of the possible positions. The components of the shift gearbox units, in particular gear selectors and clutch actuators, moreover, can be adjusted accurately and more quickly by the travel and volume control with pistons, than with proportional valves, since an additional control variable can be used on the basis of prior knowledge of the displacement volume.

Various possible embodiments of the shift gearbox according to the invention will be explained in more detail with reference to the following drawings.

In the drawings:

FIG. 1a: Twin hydraulic actuator with ten or optionally eleven solenoid valves;

FIG. 1b: Twin hydraulic actuator with three clutches;

FIG. 2: Twin hydraulic actuator with six or optionally seven solenoid valves.

FIG. 1a shows an embodiment of the actuation unit according to the invention in the form of a multi-clutch transmission.

The actuation unit comprises the sub-transmission 1, the sub-transmission 2 and the pressure supply unit 3. The pressure supply unit comprises the two piston-cylinder units or hydraulic actuators 10a and 10b. Preferably, the transmission is configured so that in a sub-transmission 1 the odd gears are arranged, and in the other sub-transmission the even gears and downshift are arranged.

Both sub-transmissions and both hydraulic actuators are constructed identically in principle, so that in the following only the sub-transmission 1 and hydraulic actuator 1 are described in more detail. For a better overview, its reference numerals are provided with the index a and c. The description also applies to the sub-transmission 2 and hydraulic actuator 2 with the corresponding change of the index reference numerals from a to b, and c to d. Also, the idea according to the invention can be extended to transmissions with different numbers of hydraulic actuator elements. More or fewer clutches C1, C2 or gear selectors 7a-d can be connected as shown here.

In the sub-transmission 1, the actuating piston 6a of the clutch actuator 4a actuates the clutch C1, not shown. The stroke is detected via the displacement sensor 5a. The clutch C1, not shown, is preferably designed so that when unactuated it is opened by the clutch spring.

The sub-transmission 1 comprises the gear selectors 7a and 7c. Again, only the function of the gear selector 7a is described. Due to the corresponding change of indices, the description also applies to the gear selector 7c, or the gear selector 7b and 7d of the sub-transmission 2.

The gear selector piston 8a actuates the respective gears of the dual-clutch transmission, not shown, via the transmission shift fork, not shown. The displacement sensor 9a detects the stroke of the gear selector piston 8a.

The gear selector 7a is designed as a double-acting piston 8a. The two gear selector chambers 21a and 22a have differently sized hydraulically effective surfaces. Both gear selector chambers are connected to the pressure line 18a constituting the first hydraulic main line, wherein the left gear selector chamber 21a can be separated from the pressure pipe 18a by the gear selector valve 20a. In addition, the left gear selector chamber 21a can be connected to the reservoir 25 by correspondingly switching the gear selector outlet valve 23a via the hydraulic line 24a.

The hydraulic actuator 1 comprises the drive motor 11a, a transmission 13a, and a hydraulic piston 14a having the hydraulic chamber 40a. The hydraulic chamber 40a can draw hydraulic fluid from the reservoir 25 via the check valve 15a and the hydraulic line 16a by the switching valves 19a, 20a, 20c and 26 being closed and the piston 14a retracting. On the other hand, if the piston 14a moves forward, the hydraulic fluid in the chamber 40a is displaced, whereby pressure is generated in the pressure line 18a. This pressure can be detected by the optional pressure transducer 17a.

The motor angle sensor detects the rotor position and can thus detect the piston stroke via the known gear ratio. Alternatively, the engine torque and thus indirectly the pressure in the hydraulic chamber 40a can be measured via a corresponding current sensor (not shown) in the electronics.

In dual-clutch transmissions, the clutches are often operated in so-called micro-slip. This is done especially with so-called wet clutches but also with dry clutches. As a result, it is necessary that the clutch actuation must be permanently readjusted. With the inventive use of two hydraulic actuators, it is possible that a hydraulic actuator permanently controls the pressure in the active clutch and the other hydraulic actuator simultaneously and independently manages the gear position of the inactive sub-transmission.

Since the clutch actuation and gear position thus take place independently of one another, it is possible to use, for example, a trapezoidal spindle as the transmission and still dispense with a pressure transducer. A trapezoidal spindle has the disadvantage compared to a ball screw of having a poorer efficiency, which can also vary over its life. Thus, the pressure estimate on the motor current becomes increasingly inaccurate. If the clutch control relies on an accurate pressure regulation, then a pressure transducer is required. This would be the case if the actuation of the active clutch has to be interrupted for a short time, e.g. to handle a gear position. However, since in the described embodiment, the clutch operation does not have to be interrupted, it is possible purely to control the clutch actuator position.

Through the connection valve 26, the two hydraulic lines 18a and 18b can be connected. Thus, it is possible to transfer the pressure from the opening clutch into the closing clutch during a quick clutch change. Thus, the hydraulic actuator of the closing clutch has to apply less power and thus can be made smaller, whereby costs can be saved.

In addition, it is possible that, e.g. in the case of failure of a hydraulic actuator, the still functioning hydraulic actuator controls the drive, the clutches and gear selector of both sub-transmission lines with appropriate performance restrictions and thus enables emergency operation. In particular, it is thus certainly possible to engage the reverse gear.

Another advantage of the connection valve is that for special cases both hydraulic actuators can operate a clutch together. This can be advantageous if the performance of a clutch actuator should not be sufficient to achieve the maximum clutch actuation force.

Nevertheless, the connection valve 26 is to be regarded as optional and is not absolutely necessary for the basic function of the transmission control.

In the described embodiment of the actuation unit of a multi-clutch transmission, all the drives of the hydraulic actuator elements are effected by the location and speed of the master cylinders 14a and 14b, or the pressure in the pressure lines 18a and 18b. The valves do not have to fulfil a pressure regulation task, but represent a pure hydraulic connection between the respective pressure chambers.

All valves shown can thus be represented as purely digitally switching 2/2-way valves. These can be designed as so-called seated ball valves. These valves are much cheaper than proportional valves and have a much lower leakage in the closed state. The electronics required for switching are also advantageously much simpler. Also, the drive logic of these valves is simpler since no thermal models, etc., are required. The seated ball valves are also smaller.

Seated ball valves in 2/2-way versions can be designed to be open or closed when currentless. In all figures, the preferred embodiment is realised. However, the respective other embodiment is also possible.

FIG. 1b shows the extension of the actuator system described in FIG. 1a to a transmission with further hydraulic actuator elements, here for example a 3rd clutches. Such transmissions are used, for example, in hybrid vehicles. There, the transmission is decoupled from the internal combustion engine by opening the 3rd clutch.

The additional clutch 41 can be connected via the additional valves 42a and 42b to the pressure lines 18a and 18b. Depending on the control logic and driving condition, this clutch can be actuated via the hydraulic actuator 1 or the hydraulic actuator 2. The clutch can be controlled via location or pressure. The clutch can be designed to be open or closed when not in operation. In addition, it is possible to operate a clutch with leakage, e.g. with hydraulic rotary feedthrough.

It is also possible to control one or more further gear selectors, not shown, by controlling them with the same switching logic.

FIG. 2 shows a further possible embodiment of the actuation unit according to the invention in the form of a multi-clutch transmission.

The actuation of the clutch actuators 4a and 4b takes place as described in FIG. 1a. Also, as shown in FIG. 1b, it is possible to have one or more other actuator elements, e.g. to control clutch actuators via a corresponding valve circuit.

Compared to FIG. 1a, here the number of switching valves for the gear position is reduced. This can be achieved by both hydraulic actuators working together at the gear position.

The following describes how the clutch actuator 4a is actively controlled simultaneously and the gear selector 7b is moved simultaneously from the illustrated central position into the right-hand end position:

First, all switching valves are closed up to 19a. The hydraulic actuator 10a directly drives the clutch actuator 4a. The pressure in the pressure line 18a is accordingly also present in the right gear selector chamber 22b of the gear selector 7b. Since the valve 20b is closed, the gear selector piston 8b does not move. Nevertheless, pressure builds up in the left gear selector chamber 21b. Since the left gear selector chamber 21b has a larger hydraulically active area than the right gear selector chamber 22b, the pressure in the left gear selector chamber is smaller in accordance with the area ratio of the two gear selector chambers.

This adjusting pressure in the left gear selector chamber 21b is now driven by the hydraulic actuator 10b. As a controlled variable, the pressure transducer 17b can be used for this purpose. Alternatively, the pressure can also be regulated with sufficient accuracy via the motor current. Now the gear selector inlet valve 20b is opened. Since a balance of forces acts on the gear selector piston 8b, this initially remains in the middle position. Now, the hydraulic actuator 10b starts to supply hydraulic fluid to the left-hand gear selector chamber 21b. At the same time, in the hydraulic actuator 10a, the master cylinder 14a is moved backward, so that the pressure in the gear selector 4a remains constant, but at the same time fluid is removed from the right gear selector chamber 22b. It is also possible during this process to modulate the pressure or location of the clutch actuator. An optional hydraulic damping element 27a can be used to reduce the influence of the pressure in the gear selector 4a by a dynamic gear shift operation.

The sequence of the switching operation of the gear selector 7b in the left end position is almost identical. Only the direction of movement of the two hydraulic actuators changes, so that the hydraulic actuator 10b withdraws fluid from the left hydraulic actuator chamber 21b and the hydraulic actuator 10a delivers fluid into the right hydraulic actuator chamber 22b.

The sequence for switching operations of the gear selector 7a-9d is analogous to the case described here by way of example. Only the corresponding gear selector inlet valve 20a-20d is opened.

It should be noted that the control of the gear selector piston 8a-8d is selected so that the pressure of the active clutch actuator 4a or 4b acts on the right gear selector chamber 22a-22d. Thus, the pressure which must be established in the respective left gear selector chamber 21a-21d, which is to be controlled, must be respectively lower than the pressure in the active gear selector 4a or 4b. Thus, the hydraulic actuators 10a-10b can be designed for the maximum required pressure for the clutch actuation and need not provide even higher pressures for the gear position. Thus, in comparison with another embodiment, e.g. as described in FIG. 1a, no higher engine torque need be provided.

By the described embodiment of the actuation unit, it is thus possible to reduce the number of switching valves required and still have the full degree of freedom in the simultaneous control of the clutch and gear position. The power requirements on the hydraulic actuator 10a and 10b thereby do not increase in relation to the embodiment in FIG. 1a.

As already described in FIG. 1a, a connection valve 26 can also be used here with the advantages already described. In addition, the connection valve can be used to discharge or to suction hydraulic fluid from the hydraulic actuators 10a or 10b into the reservoir 25. For example, when the master cylinder 14a is located in the end position illustrated, the pressure chamber 40b is hydraulically connected to the reservoir via the line 16b via a suction hole (not shown in detail). If the master cylinder 14a is advanced or retracted when the connection valve 26 is open, the volume of the hydraulic fluid in the pressure chamber 40a can be actively reduced or increased. This allows an additional degree of freedom in the control. Since this degree of freedom is not necessarily required, or only in special situations, the use of the connection valve is not required.

As already described in FIG. 1b, it is also possible here to have one or more further hydraulic actuator elements, e.g. to control a 3rd clutch actuator by being connected by this through a corresponding valve circuit to the pressure lines 18a and 18b. This embodiment is not specifically described here.

### LIST OF REFERENCE NUMERALS

1 Sub-transmission
2 Sub-transmission
3 Pressure supply unit
4a-4b Clutch actuator
5a-5b Displacement sensor clutch actuator
6a-6b Clutch actuation piston
7a-7d Gear selector
8a-8d Gear selector piston
9a-9d Displacement sensor gear selector
10a-10b Piston-cylinder unit in the form of a hydraulic actuator
11a-11b Drive motor
12a-12b Motor angle sensor
13a-13b Transmission
14a-14b Master cylinder
15a-15b Check valve
16a-16b Connection to the reservoir
17a-17b Pressure sensor
18a-18b Pressure line
19a-19b Clutch valve
20a-20d Gear selector inlet valve
21a-21d Left gear selector chamber
22a-22d Right gear selector chamber
23a-23d Gear selector outlet valve
24a-24d Connection to the reservoir
25 Reservoir
26 Connection valve
27a-27b Hydr. damping element
40a-40b Working chamber/hydraulic chamber
41 Additional clutch
42a-b Additional clutch valve
HL1, HL2 Hydraulic main lines
HLV Hydraulic connecting line

1. A shift gearbox comprising:
at least two driven piston-cylinder units, which are driven via respective transmissions by respective drives,
wherein each of the at least two piston-cylinder units each comprises a respective piston that, which delimits a respective working chamber,
at least two hydraulic main lines,
at least two gear selectors, and
at least two clutch actuators,
wherein each respective working chamber is in hydraulic connection via a respective hydraulic main line with at least one respective clutch actuator and at least one respective gear selector, whereby the clutch actuators comprise respective working chambers delimited by respective clutch actuator pistons,
wherein a valve is respectively arranged between each respective working chamber of a respective clutch actuator and a respective hydraulic main line, and
wherein both pressure build-up and pressure reduction in respective clutch actuators occurs by adjusting respective pistons of the respective piston-cylinder units.

2. The shift gearbox according to claim 1,
wherein the at least two gear selectors each have respective first and second working chambers separated by respective pistons,
wherein the working chambers of the respective clutch actuators are in connection via respective hydraulic connecting lines with respective ones of the hydraulic main lines, and
wherein the respective first working chambers of the respective gear selectors are in connection with respective hydraulic main lines by means of respective hydraulic connection lines, wherein the respective hydraulic connection lines can are enabled to be shut off by means of respective switching valves.

3. The shift gearbox according to claim 1,
wherein the at least two hydraulic main lines are connected via a hydraulic connection line, wherein a switching valve for selectively opening or closing the hydraulic connecting line, is arranged in the hydraulic connecting line.

4. The shift gearbox according to claim 2, wherein the two working chambers of respective ones of the gear selectors delimited by respective piston surfaces of the respective pistons of the gear selectors are of different sizes, larger and smaller, and
wherein the respective switching valves are arranged in the respective hydraulic connection lines that are in connection with the respective working chambers delimited by the larger piston surfaces of the respective pistons.

5. The shift gearbox according to claim 2, wherein the respective second working chambers of the respective gear selectors are connected to the same respective hydraulic main lines with which the respective hydraulic connection lines are connected, and wherein the respective switching valves associated with the respective gear selectors are arranged in these respective hydraulic connection lines.

6. The shift gearbox according to claim 2, wherein the respective second working chambers of the respective gear selectors are connected by means of respective hydraulic connecting lines to the other hydraulic main line with which the hydraulic main line of the respective gear selector is not directly connected by a respective one of the hydraulic connection lines, in which the associated switching valve is arranged.

7. The shift gearbox according to claim 2, wherein the first working chamber of at least one gear selector is connected via a hydraulic line to a reservoir, wherein a switching valve is arranged in this hydraulic line for the optional opening and shut off the hydraulic line.

8. The shift gearbox according to claim 1, wherein a control unit for adjusting at least one of the clutch actuators or gear selectors controls a respective electromotive drive, wherein a manipulated variable for the control of the electromotive drive is a rotation angle of the drive, a motor current flowing through the drive, piston location(s) and/or piston travel distance, and the respective piston associate with the respective electromotive drive thereby conveys a required hydraulic volume into or out of at least one shift gearbox unit.

9. The shift gearbox according to claim 1, wherein at least one of the clutch actuators or gear selectors comprises a location sensor or position sensor, in the form of a switch or Hall switch for determining a discrete position.

10. The shift gearbox according to claim 9,
wherein signals of the location or position sensor are used for controlling at least one of the drives and/or for calibrating a control and/or a simulation model.

11. The shift gearbox according to claim 8,
wherein pressure regulation during pressure release and/or build-up in a clutch actuator or gear selector takes place with the use of a signal from a sensor associated with a respective transmission unit.

12. The shift gearbox according to claim 9, wherein the sensor is used for detecting leakage and checking discrete locations of a piston.

13. The shift gearbox according to claim 1, wherein the shift gearbox includes a third clutch actuator whose feed line can is enable to either be shut off from the at least two hydraulic main lines or connected to one of the at least two hydraulic main lines by means of one 3/3-way valve or at least two 2/2-way valves.

14. The shift gearbox according to claim 3, wherein, for switching a first clutch, energy stored hydraulically in a second clutch is used, wherein pressure release from the second clutch takes place via the switching valve connecting the at least two hydraulic main lines with each other, or via one or more valves connecting a third clutch actuator to the at least two hydraulic main lines.

15. The shift gearbox according to claim 1, wherein at least one clutch is cooled by means of a cooling medium, wherein the cooling medium is conveyed by means of the at least two drives or a separate drive, which drives a pump.

16. The shift gearbox according to claim 1, wherein a respective drive drives a respective piston via a respective trapezoidal spindle.

17. The shift gearbox according to claim 1, wherein in case of the failure of a piston-cylinder unit, the clutch actuators and gear selectors are adjusted or are driven by means of at least one other of the at least two piston-cylinder units.

18. The shift gearbox according to claim 1, wherein flow resistances are arranged, in the form of apertures in the at least two hydraulic main lines, in sections of the at least two hydraulic main lines, connecting the clutch actuators with the gear selectors.

19. A method of controlling a shift gearbox, comprising:
either:
(a) building up pressure and reducing pressure in at least two clutches simultaneously, temporally overlapping, or successively, by means of back and forth movements of pistons of piston-cylinder units,
or
(b) building up or reducing pressure in one clutch by means of one of the piston-cylinder units and by adjusting a gear selector simultaneously, temporally overlapping, or successively by means of another one of the piston-cylinder units; and opening a valve associated with a particular one of the clutches in the case of pressure change in that particular clutch.

20. The method according to claim 19, wherein either:
(c) the pressure build-up and/or pressure reduction in a first clutch takes place via a first piston-cylinder unit and the simultaneous pressure build-up and/or pressure reduction in a second or third clutch takes place via a second piston cylinder unit,
or
(d) the pressure build-up and/or pressure reduction in the second clutch takes place via a second piston-cylinder unit and the simultaneous pressure build-up and/or pressure reduction in the third clutch takes place via the first piston-cylinder unit;
wherein in all cases valves of the shift gearbox are connected such that pressure change in one clutch does not affect pressure change in another clutch.

21. The method according to claim 19, further comprising:
for adjusting a gear selector in a first direction, initially opening a first associated valve and closing a second associated valve and then, by means of volume control, conveying just so much volume into a first working chamber of the gear selector by means of at least one of the piston-cylinder units, until a first target position of a piston of the gear selector is reached; and
for adjusting the gear selector in a second direction, opposite the first direction, closing the first associated valve and opening the second associated valve and then, by means of volume control, conveying just so much volume into a second working chamber of the gear selector by means of at least one of the piston cylinder units, until a second target position of the piston of the gear selector is reached.
